(19) United States
(12) Patent Application Publication
(10) Pub. No.: US 2007/0089829 A1
(43) Pub. Date: Apr. 26, 2007

(54) STRENGTH PEARLS

(75) Inventor: Douglas Larsen, Highland, MI (US)

Correspondence Address: DOBRUSIN & THENNISCH PC, 29 W LAWRENCE ST, SUITE 210, PONTIAC, MI, 48342, US

(73) Assignee: L&L Products, Inc.

(21) Appl. No.: 11/549,781

(22) Filed: Oct. 16, 2006

Related U.S. Application Data
(60) Provisional application No. 60/729,821, filed on Oct. 25, 2005.

(51) Int. Cl. B29C 47/00

(52) U.S. Cl. 156/244.11; 156/244.12; 156/244.24

(57) ABSTRACT

The present invention relates to a method, and resulting system, for forming a reinforcing system suitable for application to a structure of an article of manufacture. More particularly, the present invention relates to a plurality of shaped expandable segments that are movably (e.g., flexibly rotatable or the like) attached to each other for application to a cavity or other location of a structure. In one specific application, the system may be used for reinforcement of transportation vehicles such as forms of cycles (e.g., unicycle, bicycle, tricycle, etc) or other manpowered or motor powered vehicles including on-road vehicles, off-road vehicles or otherwise.

### CLAIM OF BENEFIT OF FILING DATE

The present application claims the benefit of the filing date of U.S. Provisional Application Ser. No. 60/729,821 (filed Oct. 25, 2005), hereby incorporated by reference.

### FIELD OF THE INVENTION

The present invention relates to a method, and resulting system, for forming a reinforcing system suitable for application to a structure of an article of manufacture. More particularly, the present invention relates to a plurality of shaped expandable segments that are movably (e.g., flexibly rotatable or the like) attached to each other for application to a cavity or other location of a structure. In one specific application, the system may be used for reinforcement of transportation vehicles such as forms of cycles (e.g., unicycle, bicycle, tricycle, etc) or other manpowered or motor powered vehicles including on-road vehicles, off-road vehicles or otherwise.

### BACKGROUND OF THE INVENTION

For many years industry, and particularly the transportation industry has been concerned with providing functional attributes sealing, baffling, acoustic attenuation, sound dampening and reinforcement to articles of manufacture such as automotive vehicles. In turn, industry has developed a wide variety of materials and parts for providing such functional attributes. In the interest on continuing such innovation, the present invention seeks to provide an improved material and/or improved part for providing such functional attributes. The material and/or part can provide sealing, baffling, acoustic attenuation, sound dampening, combinations thereof or the like, but the part and/or material have been found to be particularly adept at providing reinforcement.

### SUMMARY OF THE INVENTION

The present invention provides systems and methods for improving structural frame members of transportation vehicles or otherwise.

In one aspect, the present invention provides a method of forming a reinforcing system comprising the steps of: i) providing an activatable material and a flexible carrier; ii) extruding the activatable material and flexible carrier through an extruder; and iii) forming a plurality of shaped bodies about the carrier with a forming device.

In another aspect, the present invention provides a method of forming a reinforcing system comprising the steps of providing an expandable thermoplastic material and a flexible carrier. The expandable material includes one or more polymeric materials, one or more curing agents and one or more blowing agents and is activatable upon application of heat. The method also includes extruding the expandable material through an extruder for forming a generally cylindrical column of extruded material about the carrier, wherein upon extrusion the carrier is generally located within a central region of the cylindrical column of extruded material. The method further includes the step of feeding the cylindrical column of extruded material through opposing rotating cylindrical members, having a plurality of molds to plastically shape the expandable thermoplastic material about the flexible carrier, wherein upon exiting the molds the expandable thermoplastic material is formed into a plurality of commonly shaped and sized spherical segments along the flexible carrier to form a reinforcing system. The resulting reinforcing system is flexible and configured to be inserted into one or more portions having a radius.

In yet another aspect, the present invention provides a method of reinforcing a structural member of a transportation vehicle comprising the steps of: i) forming activatable material about a carrier through an extrusion device; ii) shaping the activatable material about the carrier to form a reinforcement system having a plurality of shaped bodies linkable attached by the carrier; iii) inserting the reinforcement system into a structural member of a transportation vehicle; and iv) activating the activatable material to reinforce the structural member.

It should be appreciated that the above referenced aspects and examples are non-limiting as other exists with the present invention as shown and described herein. Still further, it should be appreciated that the above referenced aspects and examples of the invention may be combined to form other unique configurations, as demonstrated in the drawings, or otherwise.

### BRIEF DESCRIPTION OF THE DRAWINGS

FIGS. 1A through 1D illustrate one configuration of the reinforcement system of present invention in various applications in a pre-activated and activated state.

FIG. 2 illustrates one method of forming the reinforcement system according to the teachings of the present invention.

### DETAILED DESCRIPTION

The present invention is predicated upon the formation of a reinforcing system having expandable material, a method of using the reinforcing system and articles incorporating the same. While the system is particularly adept at providing reinforcement it can additionally or alternatively provide functional attributes such as sealing, baffling, sound dampening, vibration dampening, acoustic attenuation, or a combination thereof. The system can be applied structures of articles of manufacture such as buildings, appliances, or the like. The system may also be used in hollow or tubular structures such as sporting equipment or otherwise. However, the system is particularly adept at providing such functional attributes to transportation vehicles (e.g., motorcycles, bicycles, boats, trains, automotive vehicles, or otherwise).

Carrier Member

In one configuration, the reinforcing system is formed through the application of one or more segments of expandable material onto a flexible carrier. The expandable material may be formed and applied to the carrier according to the various techniques.

With the flexibility characteristics of the carrier, the reinforcing system may be located within a cavity, which might inhibit location of other reinforcements therein. For example, cavities located along a contoured (e.g., arcuate bent, angled or the like) structural member can inhibit location of a non-flexible reinforcing member therein. However, the system of the present invention due to its flexibility, can follow the contours of a cavity of a structural member or otherwise.

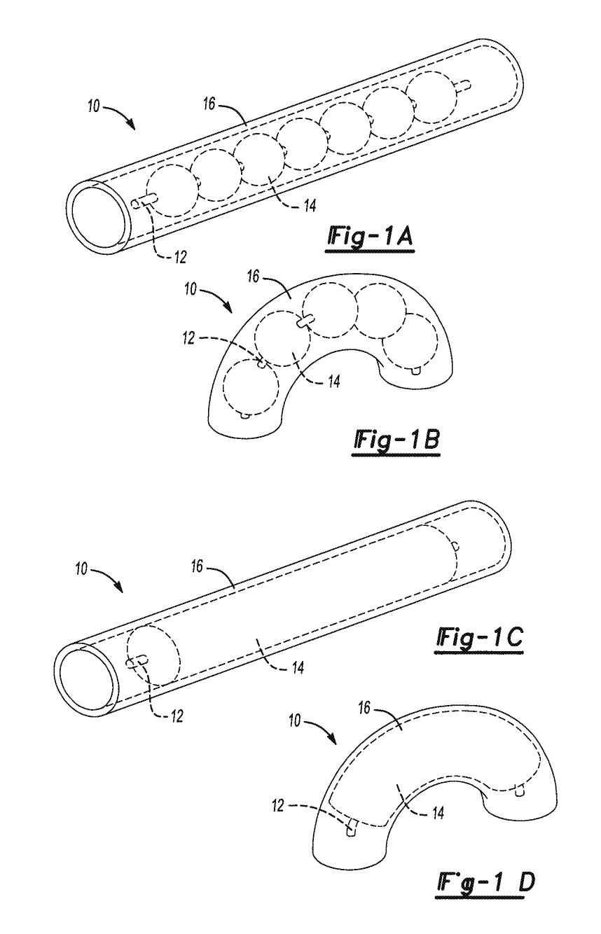

Referring to the drawings, one exemplary embodiment of the system 10 of the present invention is shown. The system includes a carrier 12 having expandable material 14 located thereon. As shown in FIGS. 1A through 1D, it should be appreciated that the reinforcing system may be placed in straight or contoured (e.g., arcuate) cavities of a structural member 16 or otherwise. However, it should be appreciated that the system may be utilized in cavities having few or no impediments (e.g., internal reinforcing walls, arcuate interior contours or otherwise). Accordingly, in one preferred embodiment, the carrier comprises a flexible member adapted to bend or otherwise allow the system to conform in shape to the interior contours of the structural member it is placed into, prior to expansion of the expandable material.

In one configuration, the carrier comprises a semi-rigid (e.g., bendable) or rigid structure adapted to be self supporting. Alternatively, in another configuration the carrier comprises a flaccid or non self supporting structure. However, in either configuration the carrier is configured for attachment with and support of a plurality of expandable material segments and is suitable in strength to maintain proximate distance relative to the segments during handling of the system.

The carrier is configured to provide a mounting structure for the expandable material prior to activation of the material. In one configuration, the carrier is also configured to provide a mounting structure during and after activation of the material. Accordingly, in one embodiment, the carrier may be temperature resistance to withstand temperatures encountered during activation of the expandable material including heat generated by a chemical reaction occurring during activation of the expandable material. Similarly, the carrier may also be configured to withstand temperatures or other applications of energy used to initiate and continue activation of the expandable material.

Alternatively, it should be appreciated that the carrier may also be configured to degrade with the application of temperature or other applications of energy to allow the expandable material to further expand during activation by removing any spatial restrictions that might be provided by the carrier.

Suitable materials available for the carrier includes flexible materials sufficient in strength to support a plurality of segments located along its length. As previously mentioned, the material of the carrier may be further configured to resist heat possibly experienced during activation of the expandable material.

The carrier may comprise of a flaccid material providing little to no resistance to bending of the reinforcing system. Alternatively, the carrier may comprise of a rigid or semi-rigid material configured for providing resistance to bending. Accordingly, the rigid or semi-rigid carrier may be configured for plastic deformation, elastic deformation or both to allow the carrier to conform to the shape of the cavity it is placed into, if needed. Also, it should be appreciated that the carrier may be shaped or conferred prior to insertion into the cavity so as to conform to at least a portion of the cavity or otherwise facilitate the insertion thereof.

Specific materials that may be used to form the carrier include without limitation metal, plastic, ceramics, cloth, fibrous materials rubber combinations thereof or otherwise. Preferred materials may include metal or cloth due to their low cost and availability. Accordingly, it is contemplated that the carrier may comprise wire, string or the like for supporting the expandable material segments. It should be appreciated that the wire, string fiber or otherwise may be flaccid, semi-rigid, rigid, combinations thereof, or otherwise.

The shape of the carrier is preferably elongated, as compared to its diameter, to provide a structure for the mounting of a plurality of segments of expandable material. In one preferred configuration the carrier is elongated and includes a circular cross sectional shape. However, the cross sectional shape may be square, triangular or otherwise.

The length of the carrier may be dependant upon the application of the system. As such, it is contemplated that the carrier may be cut to length or otherwise have a preconfigured shape. In one embodiment, it is contemplated that the length of the carrier is greater than about 10 cm, or greater than about 30 cm or even greater than about 50 cm.

As previously mentioned, the carrier may optionally be elastic or otherwise configured for elastic deformation. Accordingly, it is contemplated that the length of the carrier may increase under a tensile load. This is advantageous in certain circumstances as it can provide potential greater flexibility of the system by reducing binding between the expandable segments since the carrier connecting the segments is allowed to stretch. It is contemplated that the carrier may be configured for elongation at break or failure greater than about 40% or greater than about 100% or even greater than about 200%.

The diameter of the carrier may also be dependent upon the application of the system. However, in one embodiment, the largest diameter of the carrier is less than about 8 cm, or less than about 2 cm, or less than about 1 cm, or even less than about 0.4 cm. Similarly, the largest cross sectional area of the carrier, perpendicular to the length, may be less than about 15 cm², or less than about 8 cm², or less than about 3 cm² or even less than about 0.7 cm². As used in reference to the carrier, length is the largest overall straight dimension of the carrier and largest diameters are largest dimensions perpendicular to the length.

Expandable Material

Referring again to the drawings, the expandable material 14 is applied to the carrier 12 to form the reinforcement system 10 of the present invention. Preferably, the expandable material is molded, shaped or otherwise applied to the carrier in a plurality of segments. Preferably, the segments are at least partially spaced apart to provide flexibility of the system (e.g., avoid excessive binding of the segments of expandable material) although not required. Thus, it is contemplated that the segments may be in an abutting relationship.

In one configuration, the segments of expandable material are spaced apart in a predetermined configuration to allow optimum flexibility of the system. For example, by controlling the spacing, shape and size of the segments of expandable material, the amount of binding between the same can be controlled (e.g. minimized).

The expandable material may be applied to the carrier using molding or shaping techniques, which may be automatic, semi-automatic or manual. Such techniques include blow molding, rotation molding, injection molding, compression molding casting, or otherwise. In one highly preferred configuration, the expandable material is applied to the carrier through an extrusion (e.g. co-extrusion) process.

The segments of expandable material may comprise various three dimensional shapes including cube, cylinder, sphere, ellipsoid, cone, pyramid, tetrahedron, prism, asymetrical shapes, non-geometric shapes or otherwise. The segment may include similar or dissimilar three dimensional shapes. Also, the segments may include similar or dissimilar sizes. Accordingly, it is contemplated that the segments may include progressively larger or smaller segments along a carrier. However, in one preferred embodiment, the segments of expandable material comprise a plurality of spherical segments.

The diameter of the segments may also be dependent upon the application of the system. However, in one embodiment, the largest diameter of the segment is less than about 15 cm, or less than about 5 cm, or less than about 1.5 cm. Similarly, the largest cross sectional area of the segment, perpendicular to the length, may be less than about 25 cm², or less than about 15 cm², or less than about 5 cm² or even less than about 2 cm².

The expandable material may be formed of several different materials. Generally speaking, the member may utilize technology and processes for the forming and applying the expandable material such as those disclosed in U.S. Pat. Nos. 4,922,596, 4,978,562, 5,124,186, and 5,884,960 and commonly owned, co-pending U.S. application Ser. Nos. 09/502,686 filed Feb. 11, 2000 and 09/524,961 filed Mar. 14, 2000, and U.S. Application attorney docket no. 1001-141, filed Jun. 15, 2004, all of which are expressly incorporated by reference for all purposes. Typically, when used for reinforcement, the expandable material form a high compressive strength and stiffness heat activated reinforcement material (e.g. foam) having foamable characteristics. For example, the compressive strength modulus of the material is preferably greater than about 100 Mpa and more preferably greater than about 800 Mpa and still more preferably greater than about 1500 Mpa.

The material may be generally dry to the touch or tacky and can be placed upon the carrier member or the like in any form of desired pattern, placement, or thickness, but is preferably of substantially uniform thickness. One exemplary expandable material is L-5204 structural foam available through L & L Products, Inc. of Romeo, Mich.

Though other heat-activated materials are possible for the expandable material, a preferred heat activated material is an expandable polymer or plastic, and preferably one that is foamable. A particularly preferred material is an epoxy-based structural foam. For example, and without limitation, the structural foam may be an epoxy-based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules.

A number of epoxy-based structural reinforcing or sealing foams are known in the art and may also be used to produce the structural foam. A typical structural foam includes a polymeric base material, such as an epoxy resin or ethylene-based polymer which, when compounded with appropriate ingredients (typically a blowing and curing agent), expands and cures in a reliable and predicable manner upon the application of heat or the occurrence of a particular ambient condition. From a chemical standpoint for a thermally-activated material or a thermoset material, the structural foam is usually initially processed as a flowable thermoplastic material before curing. Such a material will typically cross-link upon curing, which makes the material incapable of further flow.

An example of a preferred structural foam formulation is an epoxy-based material that is commercially available from L&L Products of Romeo, Mich., under the designations L5206, L5207, L5208, L5209. One advantage of the preferred structural foam materials over prior art materials is that the preferred materials can be processed in several ways. The preferred materials can be processed by injection molding, extrusion compression molding, overmolding onto a carrier or with a mini-applicator. This enables the formation and creation of part designs that exceed the capability of most prior art materials. In one preferred embodiment, the structural foam (in its uncured state) generally is dry or relatively free of tack to the touch and can easily be attached to the carrier member through fastening means which are well known in the art.

While the preferred materials for fabricating the expandable material have been disclosed, the expandable material can be formed of other materials provided that the material selected is heat-activated or otherwise activated by an ambient condition (e.g. moisture, pressure, time or the like) and cures in a predictable and reliable manner under appropriate conditions for the selected application. One such material is the epoxy based resin disclosed in U.S. Pat. No. 6,131,897, the teachings of which are incorporated herein by reference, filed with the United States Patent and Trademark Office on Mar. 8, 1999 by the assignee of this application. See also, U.S. Pat. Nos. 5,766,719; 5,755,486; 5,575,526; and 5,932,680, (incorporated by reference). In general, the desired characteristics of the expandable material include relatively high stiffness, high strength, high glass transition temperature (typically greater than 70 degrees Celsius), and adhesion durability properties. In this manner, the material does not generally interfere with the materials systems employed by automobile manufacturers. Exemplary materials include materials sold under product designation L5207 and L5208, which are commercially available from L & L Products, Romeo, Mich.

Typically, when used for reinforcement, the expandable material is configured to expand to a volume that is between 110% and 500% more typically between 130% and 300% and even more typically between 150% and 250% of its original unexpanded volume. It is also contemplated that, when the system of the present invention is used for sealing or baffling, the expandable material may be designed to absorb or attenuate sound, block off and prevent passage of materials through a cavity or the like. As such, the expandable material may be configured to expand to a volume that is at least 200%, at least 400%, at least 800%, at least 1600% of even at least 3000% or its original unexpanded volume. Examples of such expandable material are discussed in U.S. application Ser. No. 10/867,835, filed Jun. 15, 2004, expressly incorporated by reference.

In applications where the expandable material is a heat activated, thermally expanding material, an important consideration involved with the selection and formulation of the material comprising the structural foam is the temperature at which a material reaction or expansion, and possibly curing, will take place. For instance, in most applications, it is undesirable for the material to be reactive at room temperature or otherwise at the ambient temperature in a production line environment. More typically, the structural foam becomes reactive at higher processing temperatures, such as those encountered in an assembly plant, when the foam is processed along with the automobile components at elevated temperatures or at higher applied energy levels, e.g., during paint curing steps. While temperatures encountered in an automobile assembly operation may be in the range of about 148.89° C. to 204.44° C. (about 300° F. to 400° F.), body and paint shop applications are commonly about 93.33° C. (about 200° F.) or slightly higher. Similarly, during manufacturing of other transportation device (e.g., bicycle, motorcycles, all terrain vehicles or otherwise), higher temperatures may also be used during coating operations e.g. painting, powder coating or otherwise. In one configuration, the material becomes reactive at temperatures greater than about 120° C., or greater than about 150° C. or even greater than about 160° C. If needed, blowing agent activators can be incorporated into the composition to cause expansion at different temperatures outside the above ranges.

By specific example, it is contemplated that the material may be cured in a powder coat and/or paint cure operation. In such an operation, the material may be exposed to a temperature range between approximately 120°-230° C. with an exposure time between about 10 minutes to 60 minutes. Also, it is contemplated that the material may be cured in a precipitation hardening cure operation. In this operation, the material may be exposed to a temperature range between approximately 150°-230° C. with an exposure time between about 45 minutes to 8 hours.

Generally, suitable expandable foams have a range of expansion ranging from approximately 0 to over 1000 percent. The level of expansion of the expandable material 30 may be increased to as high as 1500 percent or more. Typically, strength and stiffness are obtained from products that possess lower expansion.

Some other possible materials for the expandable material include, but are not limited to, polyolefin materials, copolymers and terpolymers with at least one monomer type an alpha-olefin, phenol/formaldehyde materials, phenoxy materials, and polyurethane. See also, U.S. Pat. Nos. 5,266,133; 5,766,719; 5,755,486; 5,575,526; 5,932,680; and WO 00/27920 (PCT/US 99/24795) (all of which are expressly incorporated by reference). In general, the desired characteristics of the resulting material include relatively low glass transition point, and good adhesion durability properties. In this manner, the material does not generally interfere with the materials systems employed by automotive or other vehicle manufacturers (e.g., motorcycle, bicycle, all terrain vehicles or otherwise). Moreover, it will withstand the processing conditions typically encountered in the manufacture of a vehicle, such as the e-coat priming, cleaning and degreasing and other coating processes, as well as the painting operations encountered in final vehicle assembly.

In another embodiment, the expandable material is provided in an encapsulated or partially encapsulated form, which may comprise a pellet, which includes an expandable foamable material, encapsulated or partially encapsulated in an adhesive shell. An example of one such system is disclosed in commonly owned, co-pending U.S. application Ser. No. 09/524,298 (“Expandable Pre-Formed Plug”), hereby incorporated by reference.

In addition, as discussed previously, preformed patterns may also be employed such as those made by extruding a sheet (having a flat or contoured surface) and then die cutting it according to a predetermined configuration in accordance with the chosen structure, carrier member or the like, and applying it to thereto.

The skilled artisan will appreciate that the system may be employed in combination with or as a component of a conventional sound blocking baffle, or a vehicle structural reinforcement system, such as is disclosed in commonly owned co-pending U.S. application Ser. Nos. 09/524,961 or 09/502,686 (hereby incorporated by reference).

It is contemplated that the material of the expandable material could be delivered and placed into contact with the assembly members, through a variety of delivery systems which include, but are not limited to, a mechanical snap fit assembly, extrusion techniques commonly known in the art as well as a mini-applicator technique as in accordance with the teachings of commonly owned U.S. Pat. No. 5,358,397 (“Apparatus For Extruding Flowable Materials”), hereby expressly incorporated by reference. In this non-limiting embodiment, the material or medium is at least partially coated with an active polymer having damping characteristics or other heat activated polymer, (e.g., a formable hot melt adhesive based polymer or an expandable structural foam, examples of which include olefinic polymers, vinyl polymers, thermoplastic rubber-containing polymers, epoxies, urethanes or the like) wherein the foamable or expandable material can be snap-fit onto the chosen surface or substrate; placed into beads or pellets for placement along the chosen substrate or member by means of extrusion; placed along the substrate through the use of baffle technology; a die-cast application according to teachings that are well known in the art; pumpable application systems which could include the use of a baffle and bladder system; and sprayable applications.

Extruding Device

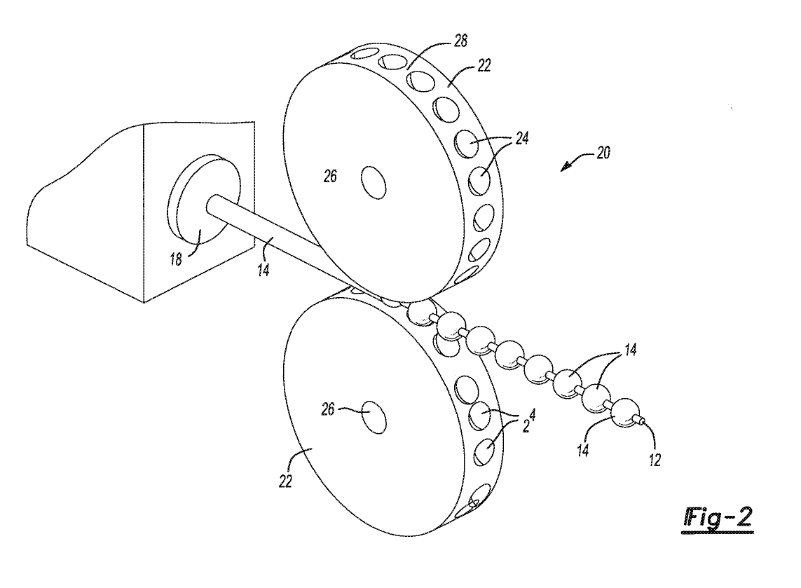

Referring to FIG. 2, an extruder and/or die 18 is adapted for extruding the mixture of expandable material. The system may be configured to extrude the expandable material in different cross sectional shapes including assymetrical, square, triangular, or otherwise. However, in a preferred configuration the expandable material is extruded in a circular cross-sectional shape and forms a cylindrical member.

Optionally, the extruder includes a mixing chamber for mixing the components to form the expandable material. Accordingly, the components of the expandable material or the expandable material itself may be fed to the extruder and mixed and subsequently extruded through the extrusion die.

In one preferred configuration, the extruder, and particularly the extruder die, is further configured to receive the carrier such that the expandable material is extruded directly on the carrier. Preferably, during extrusion the carrier is positioned within the extruded expandable material and more preferably in a central portion of the extruded expandable material. This can be accomplished using co-extrusion or other techniques.

Molding Device

Upon extrusion the reinforcement system may be complete, however, the material is preferably configured for further shaping or molding. As such, preferably the extruded material is pliable and configured for plastic deformation, particularly through the use of a molding procedure or apparatus. This pliability may be attributed to the fact that the expandable material leaves the extruder at an elevated temperature. Of course, upon cooling, the expandable material may become more rigid or may remain pliable.

Referring again to FIG. 2, an example of a molding process or machine 20 is shown. In this configuration the molding process includes a pair of opposing moving (e.g. rotation) members 22 configured with a plurality of molds 24. As shown, the members 22 are circular or cylindrical but may be shaped otherwise. The opposing rotating cylindrical members are each mounted to a support (e.g., a central support rod) 26 or the like for maintaining or adjusting the relative positions of the members during shaping of the extruded material.

In this configuration, the molding process is located proximate the extruder and preferably adjacent such that molding of the expandable material can occur within a short time period (e.g., less than 5 minutes, 1 minute or even 30 seconds) of the expandable material leaving the extruder, although not received. The molding process may further include one or more support members (not shown) for supporting or positioning the extruded expandable material after exiting the extruder. Furthermore, the support members may assist in positioning the extruded material for feeding into the molding process.

The extruded material enters the molding process, or machine preferably in a pliable form, for molding through the opposing rotating cylindrical members. As the expandable material reaches the cylindrical members, the expandable material is fed or drawn between the members and the material is introduced into the individual molds 24. The material typically fills the mold to form a prescribed three-dimensional shape as discussed herein. Preferably, the mold substantially separates the segments of expandable material through outer portion 28 of the cylindrical member leaving substantially only the carrier between the outer surface portions 28 of the cylindrical member to link the segments of expandable material together. During the molding of the expandable material, the carrier remains within a central portion of the expandable material. As the mold forms the segments of expandable material, the carrier links the segments together.

Upon completion of the molding process, a section of linked segmented expandable material is separated (e.g. by cutting the carrier material) to form the reinforcing system of the present invention. Alternatively, the entire strand of linked segmented expandable material may form the reinforcing system.

The reinforcing system of the present invention may be utilized in various aspects of structural reinforcement, particularly in the transportation industry for motorcycles, bicycles, automotive vehicles, boats, trains, or otherwise. In one particularly advantageous application, the reinforcing system of the present invention may be used for application to relatively small and/or relatively contoured or complex structural members such as frame members having small and/or arcuate cavities formed therein.

The reinforcement system, or segments, may include a diameter roughly corresponding to the cross-sectional size of the structural member it is placed into. In view of the expandable nature of certain activatable materials, as described herein, it is contemplated that the structural member may include a diameter of 100%, 110%, 125%, 150%, 200% or greater of the diameter of the reinforcement system or segments. Accordingly, it is contemplated that the internal diameter of the structural member at location to be reinforced may be less than about 15 cm, or less than about 5 cm, or less than about 1.5 cm. Similarly, the largest cross sectional area of the structural member to be reinforced, perpendicular to the length, may be less than about 25 cm², or less than about 15 cm², or less than about 5 cm² or even less than about 2 cm². Of course, the diamteres or cross-sections may be larger unless otherwise specified.

In one example, the reinforcing system may be used to reinforce various tube sections, and/or tube assemblies, wherein the tubes can include internal cavities that are straight, contoured or combinations thereof. This may include hydroformed tubes or otherwise. Such reinforcement may be particularly desirous in sections of the tubing subjected to higher concentration of stress or otherwise more susceptible to failure. This is particularly advantageous so as to improve the strength to weight ration of the tubing, through local reinforcement, as oppose to increasing the wall thickness of the entire tubing that would unnecessarily increase the weight and cost of the tube member or assembly. Accordingly, the reinforcement system may be used to reinforce a portion of the structural reinforcement (e.g. tube or otherwise) or the entire structural member.

In another example, it has been found that the reinforcing system of the present invention is particularly useful in the reinforcing of transportation devices such as bicycles. In such applications, the reinforcing system is inserted into a cavity of a structure and travels along any contours of the structure to its final destination. Subsequently, the expandable material is activated causing the material to expand and form a foam that preferably substantially fills the cavity in the desired location. The expandable material also preferably melts and adheres to walls of the structure or structural member defining the cavity. Upon curing, the reinforcement system provides reinforcement of the structure it is placed within. The reinforcement system is also configured for providing vibration dampening of the structure it is placed within.

In another application, the reinforcing system of the present invention may be used with sporting equipment, particularly equipment formed having a hollow or tubular structure (e.g., bats formed of metal or wood or otherwise, hockey sticks formed of metal or wood or composite material or combinations thereof or otherwise, la cross sticks, or otherwise). As such, it is contemplated that the reinforcement system may be placed within the tubular structure prior to heating or hardening of the tubular structure (such as precipitation aging process, powder coat paint curing, or otherwise). Advantageously, during heating of the hollow structure, the reinforcing system expands to fill the hollow or tubular structure and provide reinforcement and/or vibration dampening thereto. Of course, other forms of energy may be used to activated and expand the material of the reinforcing system as described herein or otherwise. Also, it is contemplated that the system may be used for repairing hollow or tubular structures (e.g., hockey sticks, or otherwise). Furthermore, the system may be used for reinforcement of protective gear worn or used during participation in sporting activities.

In still other potential applications, the reinforcement system may be used to reinforce other products made of, or otherwise including, tubing such as patio furniture, handrails, curtain rods, lawn mower handles, ultra light aircraft and/or Hang gliders, children swing sets, barbecue grills, tubes that support dancers, gymnast or the like, or otherwise.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A method of forming a reinforcing system comprising the steps of:
providing an activatable material and a flexible carrier;
extruding the activatable material onto the flexible carrier through an extruder; and
forming a plurality of shaped bodies about the carrier with a forming device.

2. The method of claim 1, wherein the activatable material and flexible carrier are formed of different materials.

3. The method of claim 1, wherein the activatable material and flexible carrier or formed of the same material.

4. The method of claim 1, wherein the activatable material is a heat activatable and expandable material.

5. The method of claim 1, wherein, upon exiting the forming device, the carrier supports the plurality of shaped bodies.

6. The method of claim 1, wherein, during extrusion, the activatable material is formed about the carrier and the carrier is located generally along an axis of the reinforcing system.

7. The method of claim 1, wherein the forming device comprises two opposing compression devices having molds formed therein for forming the plurality of shaped bodies.

8. The method of claim 7, wherein the two opposing compression devices are configured to rotate about a support member to cause opposing mold portions to align opposite one another to form the plurality of shaped bodies.

9. The method of claim 8, wherein the plurality of shaped bodies are substantially supported by the carrier.

10. The method of claim 1, wherein the forming device forms commonly shaped bodies of activatable material.

11. The method of claim 1, further comprising the step of periodically cutting the carrier member upon exiting the forming device to form a plurality of reinforcement systems.

12. A method of forming a reinforcing system comprising the steps of:
providing an expandable thermoplastic material and a flexible carrier, the expandable material including one or more polymeric materials, one or more curing agents and one or more blowing agents, the expandable material being activatable upon application of heat;
extruding the expandable material through an extruder for forming a generally cylindrical column of extruded material about the carrier, wherein upon extrusion the carrier is generally located within a central region of the cylindrical column of extruded material; and
feeding the cylindrical column of extruded material through opposing rotating cylindrical members having a plurality of molds to plastically shape the expandable thermoplastic material about the flexible carrier, wherein upon exiting the molds the expandable thermoplastic material is formed into a plurality of commonly shaped and sized spherical segments along the flexible carrier to form a reinforcing system, and wherein the resulting reinforcing system is flexible and configured to be inserted into one or more portions having a radius.

13. A method of reinforcing a structural member of a transportation vehicle comprising the steps of:
forming activatable material about a carrier through an extrusion device;
shaping the activatable material about the carrier to form a reinforcement system having a plurality of shaped bodies linkable attached by the carrier;
inserting the reinforcement system into a structural member of a transportation vehicle; and
activating the activatable material to reinforce the structural member.

14. The method of claim 13, wherein the step of shaping of the plurality of shaped bodies is achieved through opposing rotating devices each having a plurality of molds configured to align with one another.

15. The method of claim 13, wherein the structural member is contoured with one or more bends along its length.

16. The method of claim 15, wherein the plurality of shaped bodies are flexibly attached to one another through the carrier.

17. The method of claim 16, wherein during insertion the reinforcing system is configured to flex and conform in shape to the contours of the structural member.

18. The method of claim 13, wherein the transportation vehicle comprises a bicycle.

19. The method of claim 13, wherein upon activation the activatable material expands to fill at least a portion of the structural member.

20. The method of claim 13, wherein during extrusion the activatable material is formed about the carrier and the carrier is located generally along an axis of the reinforcement system.
